(19) United States
(12) Patent Application Publication
(10) Pub. No.: US 2012/0079991 A1
(43) Pub. Date: Apr. 5, 2012

(54) Large scale aquarium

(76) Inventor: Kristin L. Mertz, Miami, FL (US)

(21) Appl. No.: 12/924,606

(22) Filed: Oct. 1, 2010

(51) Int. Cl. A01K 63/04

(52) U.S. Cl. 119/264

(57) ABSTRACT

The inventive concept is directed to a large self-sustaining aquarium which is constructed as half round tank having a diameter of at least 10′. The front of the half round tank has a flat viewing area of glass. The inside of the tank, at the half round outer wall, there located a secondary wall in front of the outer wall by a distance of about 10 inches to thereby form a reservoir. A multiple baffles are located in this reservoir spaced apart from each other. The baffles are so located that they alternating touch the bottom of the tank or are spaced apart there from. Thus, when awter is forced into a first one the cells, the water will take a serpentine flow direction through the reservoir. Various water treatment elements are located within each of the cells to maintain the water free of any particles and other contaminants to render the aquarium self-sustaining.

### BACKGROUND OF THE INVENTION

Aquariums are known and they come in all different sizes. The most common aquariums are of the home type and some are used in offices as the home or office type aquariums need constant attention and the fish in the water have to temporarily be removed because the water has to replaced with clean water.

The same problem arises in large aquariums that are used in zoos and water exhibitions where large aquariums are on display and are stocked with a large numbers and fish and other water animals reside for the enjoyment of the public. These large scale aquariums need the same constant attention as home type aquariums do because of a build-up of various contaminants that are detrimental to lifes of the fish.

Large areas of water collections are found in swimming pools which also need constant attention because swimming pools are concerned with sterilizing the water for health purposes of the swimmers. The water has to be maintained with a residual oxidizer, that is, chlorine.

An aquarium is more concerned with biological processes to mimic the natural environment. This requires a different method and filtration process. The inventive aquarium is designed to closely mimic mother nature using both natural and mechanical processes.

### BRIEF DESCRIPTION OF THE INVENTION

The aquarium is a large scale aquarium of at least 10′ diameter half round construction with a 6′×8′ acrylic window installed on the flat side of the half round curved round wall. This window is the observation or viewing are of the aquarium. There is a second interior tank wall placed inwardly about 10 inches from the tank's curved outer wall. This interior space is subdivided by vertical baffle walls which alternate in that every other one extends to the water surface or extends to the tank space bottom. Theses alternating baffles create filter cells. The operation of these filter cells will be described below under the heading of operation.

### BRIEF DESCRIPTION OF THE DRAWINGS

FIG. 1A shows the curved tank with the operating elements installed mostly on the left side.

FIG. 1B shows the curved tank with the operating elements mostly installed on the right side.

FIG. 1C shows the curved tank with all the operating elements installed ready for operation.

FIG. 2 is a plain frontal view of the curved tank of FIGS. 1A-1C.

FIG. 3 is view of the left side of the curved tank including a sight-glass.

FIG. 4 I s atop view of the curved tank.

### DETAILED DESCRIPTION OF THE INVENTION

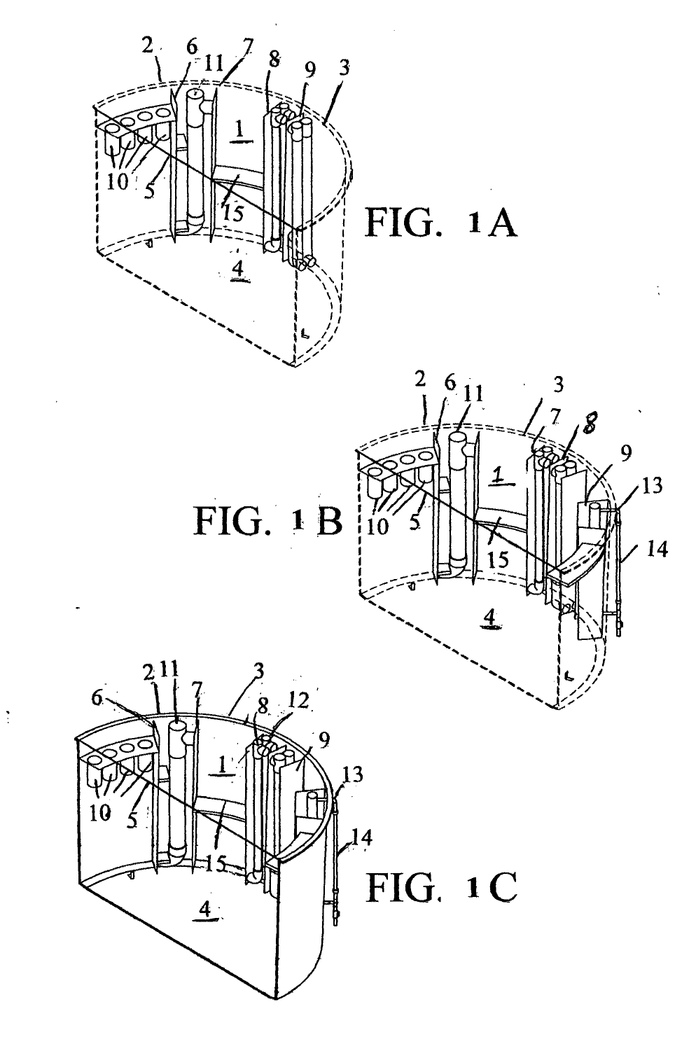

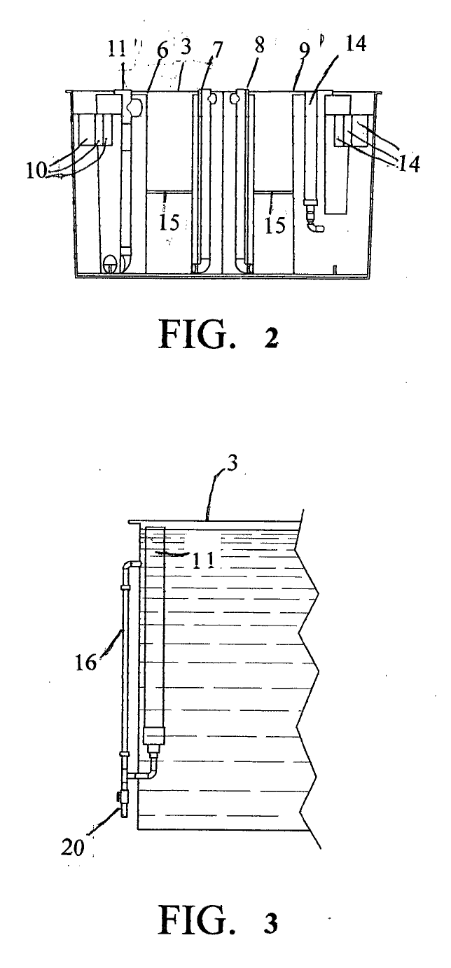

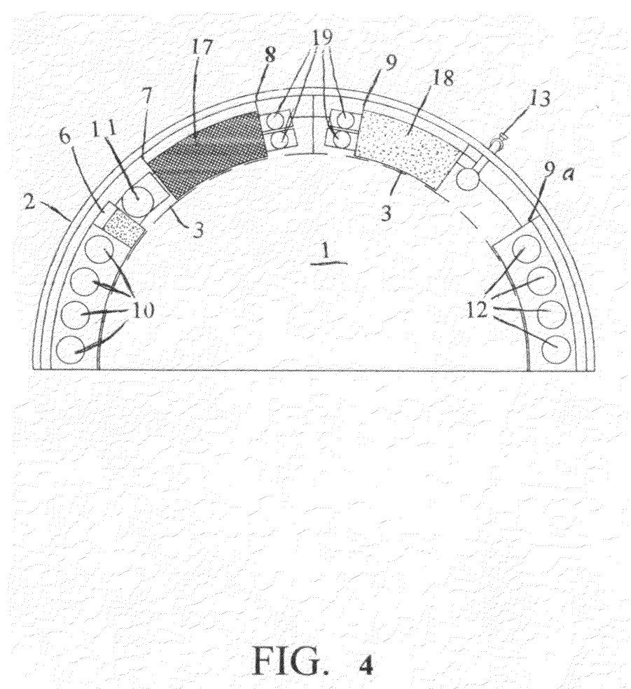

FIGS. 1A-1C have the same elements with the same call outs. In FIG. 1A The interior of the half round tank has been designated as 1. The rear curved out wall is shown at 2. As mentioned above, there is a second interior wall 3 set inwardly from the curved wall 2 by way of a distance of about 10 inches to thereby form in interior tank space. The interior space is subdivided by baffles 6, 7, 8 and 9 as seen from left to right. The baffles are alternating in position. The first baffle 6 is so positioned that the lower end touches the bottom of the tank 1 and ends at just the water level on top. The next baffle 7 does not reach the bottom of the tank and so baffles 8 and 9 alternate in theses positions. Theses alternating cells create filter cells. The cells are bisymmetrically configured though the individual cell functions vary. The left cells are as follows: mechanical filtration through four bag filters 10. Then through a 260 watt U.V. sterilizer. The third cell has an algae scrubber refugium.

In FIG. 5 on the right side of the aquarium again there the same bag filters 12. In the next cell there is located a combination of counter current foam fractionator/bio reactor 18 with a fluidized medium. A secondary pump (not shown) is used. In the middle cell there is located a grate 15. Air lifts 19 are located in the middle of the curved tank. The reservoir has a sight glass 16 (FIG. 3).

### OPERATION

When water is removed from the inner most cells, either with a pump (not shown) or an air lift 19, the water replacing it must pass through the outermost cell first and then through coinciding successive cells thereby creating a serpentine water path through the filter cells. The first cells are fit with socks or bag filters for particle removal (there are 4 at each end. Water flows down throughis fit he bags, which functions as a surface skimmer. The water then flows out through the bottom of the first cell into the second cell where it rises to the top and then flows down into cell 3 and so on. Each cell can be configured for a particular portion of the of the overall filtration system. At present, the cells are so configured that water flows from each corner, through a skimmer which feeds both surface and bottom water down through the particulate and or mechanical filtration. The cells are of a bisymmetrical configuration, though the individual cell functions vary. The left cells are as follows: mechanical filtration (4 bag filters), up through a 260 watt U.V. sterilizer, down through an algae scrubber,

Then air lifted up to a central cell

Or return plenum, which is vented a the bottom for return to the tank. The right side of the aquarium has the same 4 bag filters and the water is up-flowing into a pump and storage cell (not shown)down through a combination counter current foam fractionator/bio reactor with fluidized bio media. A second pump (not shown) is used to draw filtered water from the cell and power circulating jets, a venturi to aid in foam fraction. The water is then fed to the top where two small tanks (note shown) are used for degas/bio filter media and for a surge reservoir. The surge system has a pair of prototype vacuum triggered siphon lines feeding oversized pulse jet lines to create surge and erratic water movement. As the water is sprayed into the degas tanks they begin to fill. The vacuum from the venturi is fit to an air relief at the apex of the bend in the siphon tube. The air is evacuated from the tube and initiates a siphon, which rapidly drains the reservoir creating a pulse of water.

The entire life support system is contained within the envelope of the fiberglass tank. All major filtration components and their respective elements are accessed from the top of the tank, along its curved perimeter. The sight glass lets the operator know when the sludge build up is to be drained via a dump valve. The top of the sight glass penetration also acts as an aquarium overflow.

What I claim is:

1. A large scale self-sustained aquarium constructed as a half-round water container acting as tank having a first half round wall, a front wall of the half round container has a large viewing glass wall, a second half round wall is constructed abut 10 inches from said first round half wall within said tank acting as a reservoir, a multiple of baffles are located within said reservoir, said baffles spaced apart from each forming cells, Each of said baffles are so placed within said reservoir that they alternate in position relative to a bottom said tank to alternating touching said bottom or being spaced there from, therefore when water is forced into a first cell it moves in a vertical serpentine fashion through said reservoir.

2. The aquarium of claim 1, wherein said tank is constructed of fiber glass.

3. The aquarium of claim 1, wherein in one said cells has located therein a U.V. strerilizer.

4. The aquarium of claim 3, wherein said sterilizer has energy rating of 260 watts.

5. The aquarium of claim 1, wherein there are located at least four filter bags are located in some of those cells at the beginning of the water flowing through said reservoir and at least four filters are located at an end of said reservoir.

6. The aquarium of claim 1, wherein in one of said cells there is located an algae scrubber.

7. The aquarium of claim, including a sight glass located on an outside of said aquarium.
